(19) United States
(12) Patent Application Publication
(10) Pub. No.: US 2008/0063928 A1
(43) Pub. Date: Mar. 13, 2008

(54) Battery holding structure for electronic device

(75) Inventor: Tzu-Chih Lin, Hsinchu County (TW)

Correspondence Address: BIRCH STEWART KOLASCH & BIRCH, PO BOX 747, FALLS CHURCH, VA, 22040-0747, US

(73) Assignee: Altek Corporation

(21) Appl. No.: 11/605,232

(22) Filed: Nov. 29, 2006

(30) Foreign Application Priority Data
Sep. 13, 2006 (TW) 095216319

(51) Int. Cl. H01M 2/10

(52) U.S. Cl. 429/97; 429/100; 429/99

(57) ABSTRACT

A battery holding structure for an electronic device is provided, which includes a battery chamber having an opening, a fixing member and a cover. The fixing member has a cantilever extending from the battery chamber to the opening. The cantilever has a pressing portion at the opening, and the cover has a pushing portion corresponding to the pressing portion. When the cover covers the opening, the pushing portion presses against the pressing portion and fixes the battery installed in the battery chamber.

### CROSS-REFERENCE TO RELATED APPLICATIONS

This non-provisional application claims priority under 35 U.S.C. § 119(a) on Patent Application No(s). 095216319 filed in Taiwan, R.O.C. on Sep. 13, 2006, the entire contents of which are hereby incorporated by reference.

### BACKGROUND OF THE INVENTION

1. Field of Invention

The present invention relates to a holding structure, and more particularly to a battery holding structure for an electronic device.

2. Related Art

The current high-tech brings considerable convenience to human beings, and in an age of fast information accumulation, electronic products have become indispensable in people's work and daily life. The gradual popularization of products concerning computer, communication and consumer electronics will bring great convenience to the users.

For digital cameras, most of the commonly seen digital cameras are powered by batteries. As various batteries are sold in the market, it may result in the fact that the batteries are slightly different in size, such that a gap may appear between the battery installed in the battery chamber of a fixed size and the spring contact due to the difference in the weight and size of the battery. Being lighter and thinner, the digital camera is easy to drop to the ground or be collided if the user fails to hold it tight, which may cause the battery to be departed from the spring contact under a counterforce generated by shake, vibration or collision of the digital camera, and thus result in a power failure.

To solve the above problem that the digital camera is easy to be powered off under an external force, a capacitor is added in the digital camera for storing a stand-by power. When the digital camera is suddenly powered off due to shake or collision, the stand-by power stored in the capacitor can be directly used to power the digital camera, thus avoiding the problem of power off. Furthermore, the spring force of the conductive spring sheet electrically contacted with the battery and the weight of the battery can be increased to avoid generating a gap as the battery is excessively light or the spring force of the conductive spring sheet electrically contacted therewith is excessively small when the digital camera is suffered from shake or collision, thereby preventing the problem of power off.

In a conventional device for preventing the power off of a digital camera, a capacitor must be added or the spring force of the conductive spring sheet and the weight of the battery must be increased. As the spring force of the conductive spring sheet is increased, the strength of the cover structure installed outside the battery chamber must be enhanced accordingly to withstand the counterforce generated by the conductive spring sheet. Therefore, whether the strength of the camera cover can bear the repeated acting force must be considered additionally, and thus the process cost is increased accordingly. Moreover, the increase in the weight of the battery results in the increase in the weight of the digital camera. However, the over-weighted digital camera can not meet the practical requirements of the current consumers on light and thin consumptive electronic products.

### SUMMARY OF THE INVENTION

Accordingly, the present invention is directed to provide a battery holding structure for an electronic device, so as to eliminate the disadvantage of the prior art that the battery installed in the digital camera can not be fixed, and thus the camera is easy to be powered off due to the collision of the external force.

In order to achieve the above objective, the present invention provides a battery holding structure for an electronic device, which comprises a battery chamber, a fixing member and a cover. An accommodation space with an opening is provided in the battery chamber for installing a plurality of batteries. The fixing member has a cantilever disposed in the battery chamber and extending to the opening, wherein a pressing portion is disposed on the cantilever extending to the opening. The cover selectively covers the opening and has a pushing portion corresponding to the pressing portion. When the cover covers the opening, the pushing portion presses against the pressing portion to fix the plurality of batteries.

The efficacy of the present invention is to fix the battery through a corresponding pressing portion and pushing portion. When the user puts the cover on the opening of the battery chamber, the pressing portion presses against the battery in the battery chamber to fix the battery at an electrically conducting position at the same time, such that the battery is not easy to be departed from the electrically conducting position under external forces such as shake and collision.

The above illustration on the content of the present invention and the following illustration on the embodiments of the present invention are given for demonstrating and explaining the principle of the present invention, and the claims of the present invention are provided for further explanations.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and thus are not limitative of the present invention, and wherein:

FIG. 1 is an exploded schematic view of a first embodiment of the present invention;

FIG. 2 is a schematic stereogram of the first embodiment of the present invention;

FIG. 3 is a schematic stereogram of the first embodiment of the present invention;

FIG. 4A is a schematic sectional view of the pushing portion pressing against the pressing portion according to the first embodiment of the present invention;

FIG. 4B is a schematic sectional view of the pushing portion being departed from the pressing portion according to the first embodiment of the present invention;

FIG. 5 is an exploded schematic view of a second embodiment of the present invention;

FIG. 6 is a schematic stereogram of the second embodiment of the present invention;

FIG. 7 is a schematic stereogram of the second embodiment of the present invention;

FIG. 8 is a schematic stereogram of the second embodiment of the present invention;

FIG. 9A is a schematic sectional view of the pushing portion pressing against the pressing portion according to the second embodiment of the present invention;

FIG. 9B is a schematic sectional view of the pushing portion being departed from the pressing portion according to the second embodiment of the present invention;

FIG. 10 is an exploded schematic view of a third embodiment of the present invention;

FIG. 11 is a schematic stereogram of the third embodiment of the present invention;

FIG. 12 is a schematic stereogram of the third embodiment of the present invention;

FIG. 13 is a schematic stereogram of the third embodiment of the present invention;

FIG. 14A is a schematic sectional view of the pushing portion pressing against the pressing portion according to the third embodiment of the present invention; and

FIG. 14B is a schematic sectional view of the pushing portion being departed from the pressing portion according to the third embodiment of the present invention;

### DETAILED DESCRIPTION OF THE INVENTION

According to the battery holding structure for an electronic device disclosed by the present invention, the electronic device includes, but not limited to, electronic devices that have to be powered by batteries such as digital cameras, portable disks and MP3 players. In the following detailed illustration of the present invention, a digital camera is taken as the most preferred embodiment. Moreover, the appended drawings are given for reference and illustration only, instead of limiting the present invention.

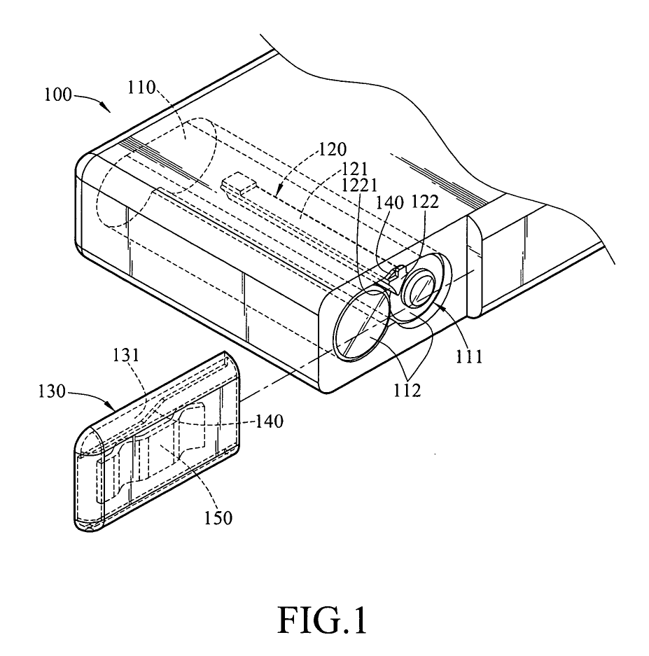

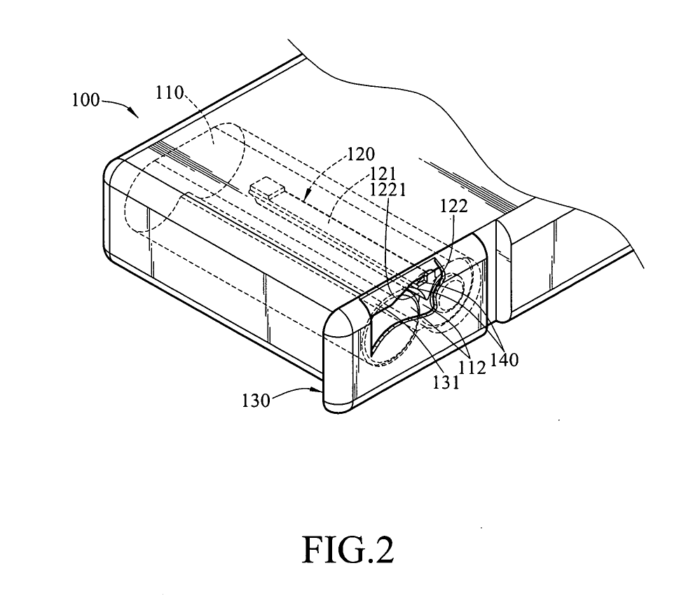

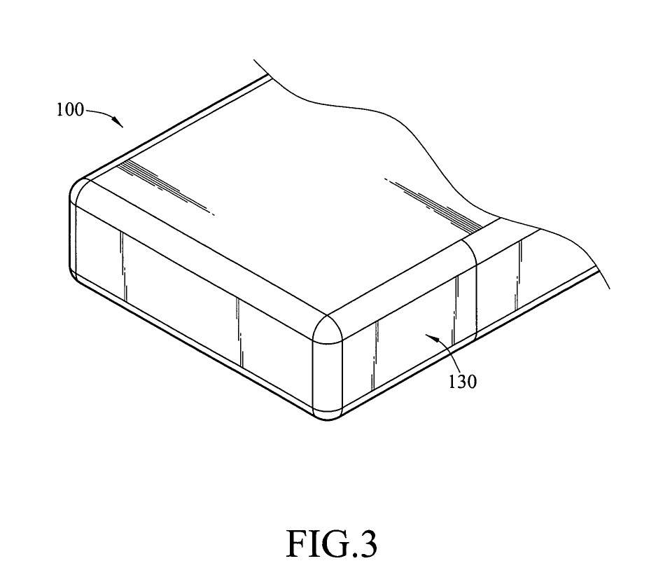

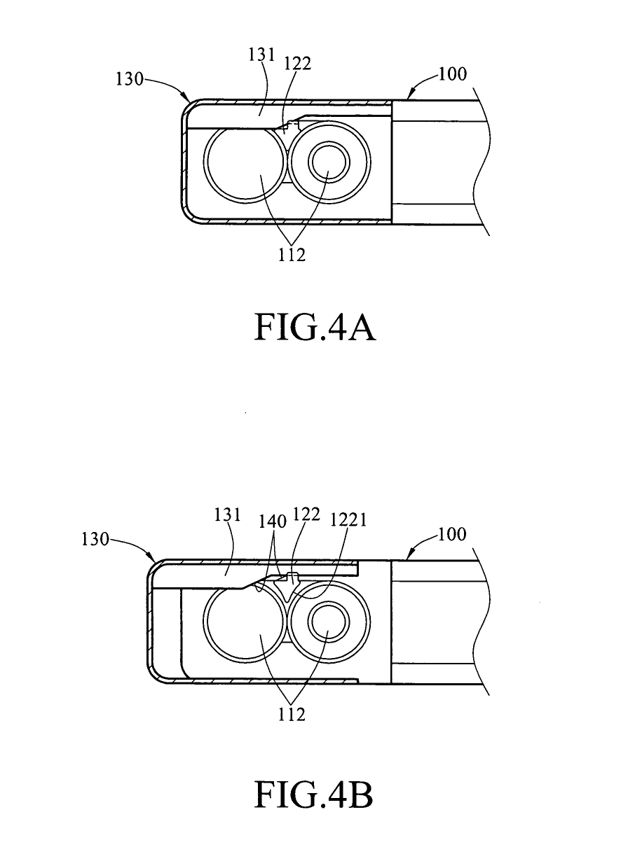

FIGS. 1 to 4B are schematic spatial views and schematic sectional views according to the first embodiment of the present invention. As shown in the figures, the battery holding structure for an electronic device 100 disclosed by the present invention includes a battery chamber 110, a fixing member 120 and a cover 130. An accommodation space with an opening 111 is provided in the battery chamber 110 for fitly installing a plurality of batteries 112. One end of the fixing member 120 is disposed on a wall face of the battery chamber 110, and the fixing member 120 has a cantilever 121 suspended in the accommodation space and extending to the opening 111 in a direction parallel to the axial direction of the plurality of batteries, such that the cantilever 121 can move perpendicularly in the battery chamber 110. A pressing portion 122 is disposed on the cantilever 121 at the opening 111, and the cover 130 selectively covers the opening 111 for preventing the batteries 112 from slipping out of the battery chamber 110. The cover 130 has a pushing portion 131 corresponding to the pressing portion 122 and a conductive spring sheet 150 on one side relative to the battery chamber 110, and the two corresponding side edges of the pressing portion 122 and the pushing portion 131 are respectively provided with an inclined surface structure 140.

When the cover 130 is moved to cover the opening 111 of the battery chamber 110 for installing the plurality of batteries 112, the inclined surface structure 140 of the pushing portion 131 contacts the inclined surface structure 140 of the pressing portion 122 at a higher level. When the cover 130 covers the opening 111 and the conductive spring sheet 150 is electrically contacted to the batteries 112, the pressing portion 122 of the fixing member 120 is pressed downward by the pushing portion 131 of the cover 130, and the batteries 112 in the battery chamber 110 are fixed at an electrically conducting position. After the user removes the cover 130 from the opening 111 of the battery chamber 110, the fixing member 120 is released by the pressing force and elastically recovered to the original position, and meanwhile the batteries 112 fixed in the battery chamber 110 are loosened.

An arc-shaped structure 1221 matching the shape of the outer edge of the batteries 112 is disposed on one side of the pressing portion 122 relative to the plurality of batteries 112. When the cover 130 covers the opening 111, the arc-shaped structure 1221 of the pressing portion 122 is attached to the outer edge of the batteries 112 to obtain a more preferable pressing force, so as to avoid the loosening of the batteries 112 from the fixing member 120 due to an excessively small contact area between the tubular batteries 112 and the pressing portion 122.

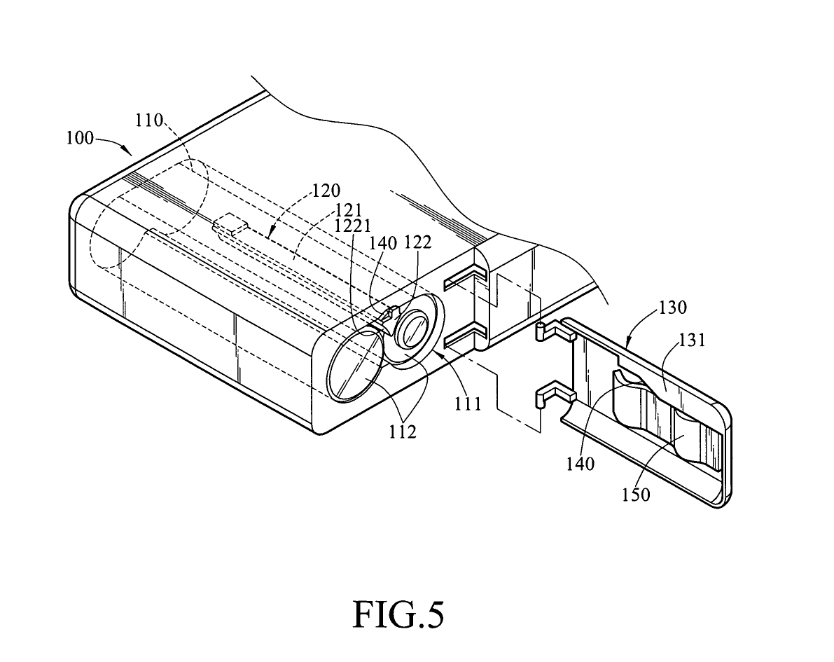

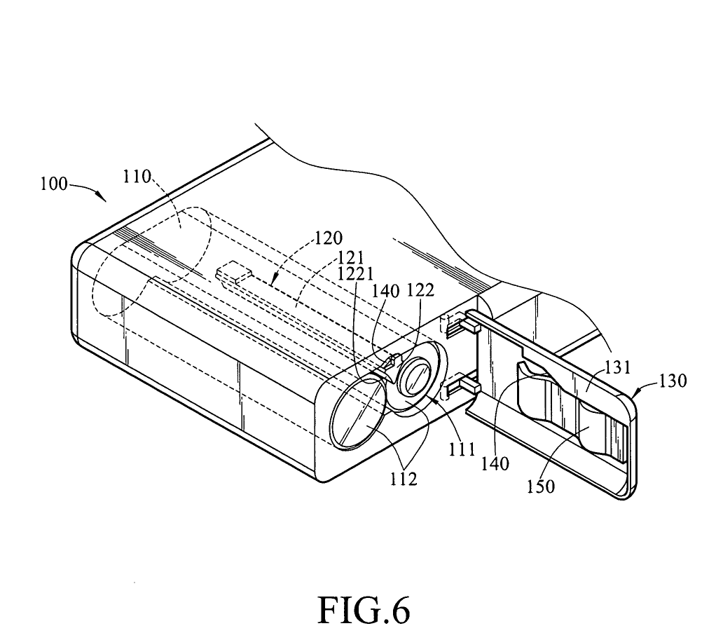

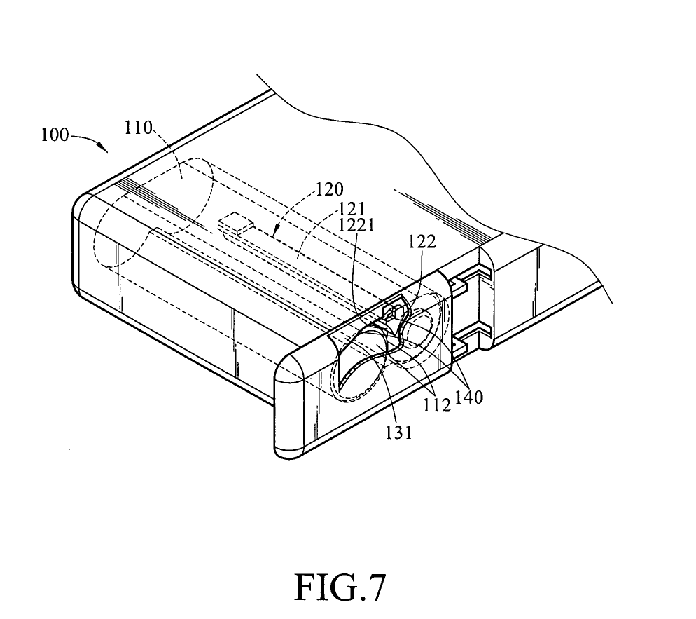

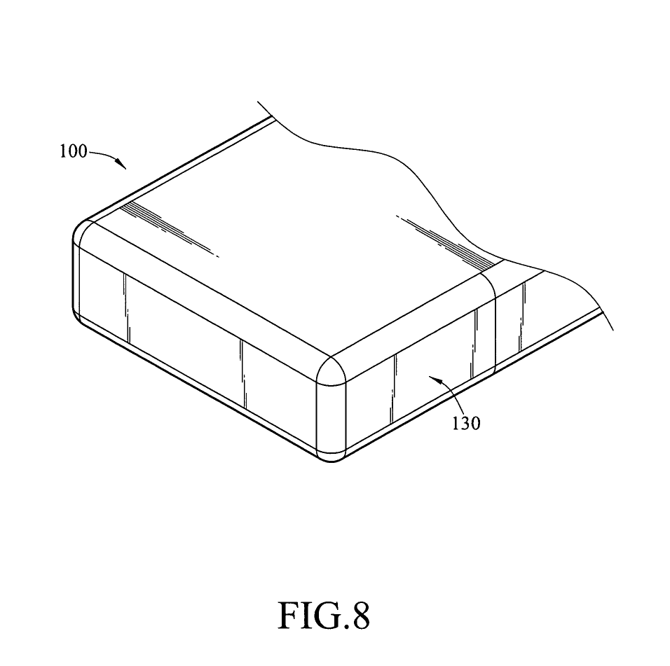

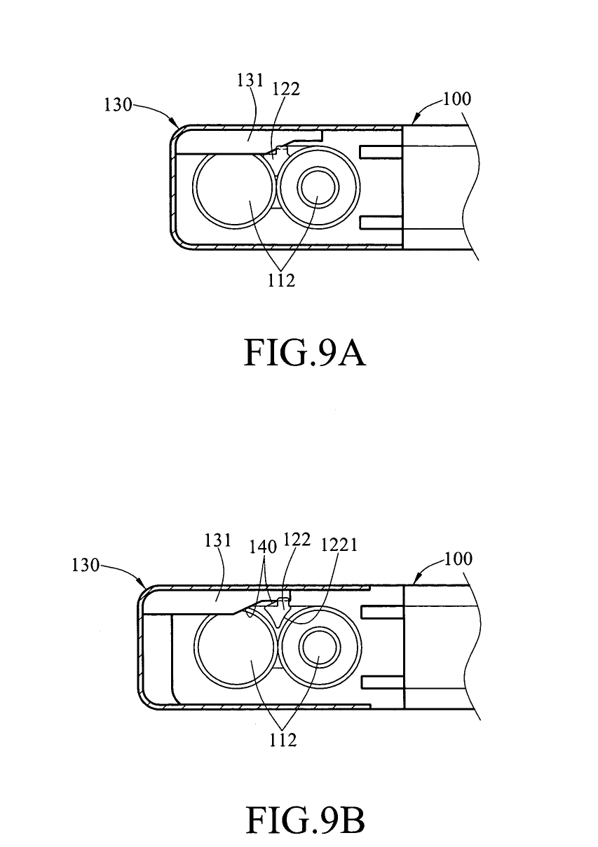

FIGS. 5 to 9B are schematic spatial views and schematic sectional views according to the second embodiment of the present invention. As shown in the figures, the battery holding structure for the electronic device 100 disclosed by the present invention includes a battery chamber 110, a fixing member 120 suspended in the battery chamber 110, and a cover 130. An accommodation space with an opening 111 is provided in the battery chamber 110 for fitly installing a plurality of batteries 112. The fixing member 120 has a cantilever 121 parallel to the axial direction of the batteries 112 and extending to the opening 111 of the battery chamber 110, and a pressing portion 122 is disposed on one end of the cantilever 121 at the opening 111. The cover 130 is pivoted to one end of the opening 111 and selectively covers the opening 111 for preventing the batteries 112 from slipping out of the battery chamber 110. The cover 130 is provided with a pushing portion 131 corresponding to the pressing portion 122 and a conductive spring sheet 150 on one side relative to the battery chamber 110, and the two corresponding side edges of the pressing portion 122 and the pushing portion 131 are respectively provided with an inclined surface structure.

When the cover 130 rotates and covers the opening 111 of the battery chamber 110 for installing the plurality of batteries 112 in the horizontal direction, the conductive spring sheet 150 is electrically contacted with the batteries 112 for conducting power. The pressing portion 122 of the fixing member 120 presses against the batteries 112 under the pressing force from the pushing portion 131 of the cover 130 in the horizontal direction, so as to fix the batteries 112 at the electrically conducting position. When the user removes the cover 130 from the opening 111, the fixing member 120 is released by the pressing force and elastically recovered to the original position, and the batteries 112 fixed in the battery chamber 110 are loosened.

An arc-shaped structure 1221 matching the shape of the outer edge of the batteries 112 is disposed on one side of the pressing portion 122 relative to the plurality of batteries 112. When the cover 130 covers the opening 111, the arc-shaped structure 1221 of the pressing portion 122 is attached to the outer edge of the batteries 112 to obtain a more preferable pressing force, so as to avoid the loosening of the batteries 112 due to an excessively small contact area between the tubular batteries 112 and the pressing portion 122.

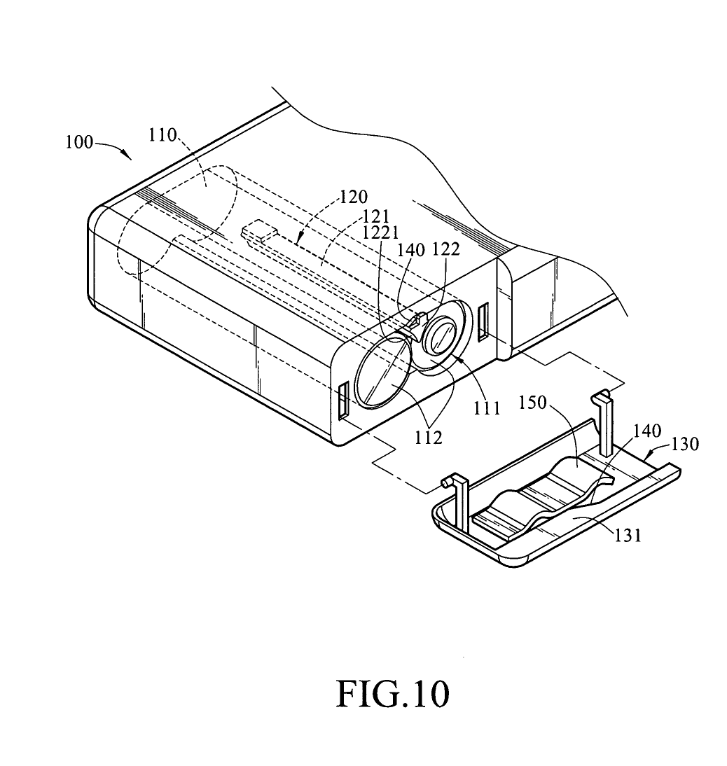

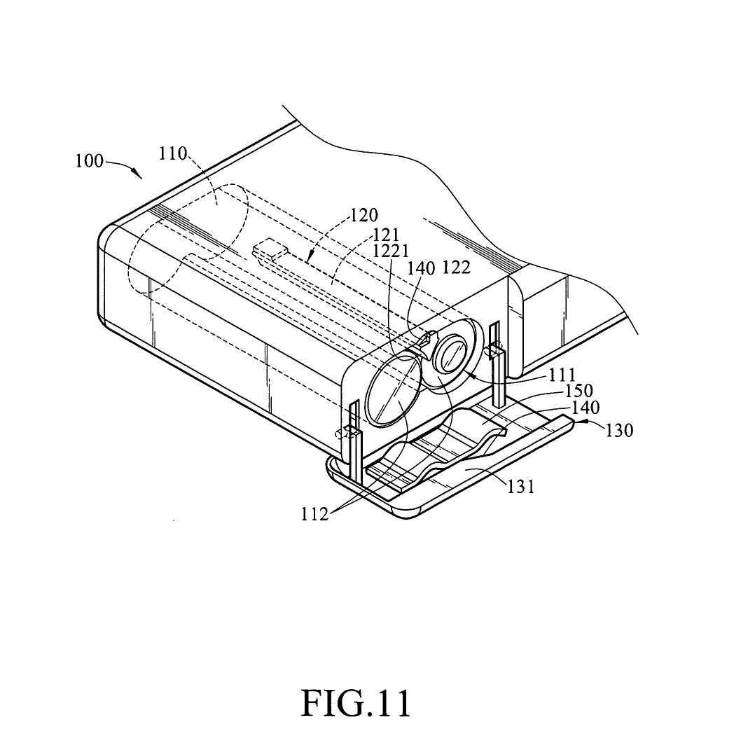

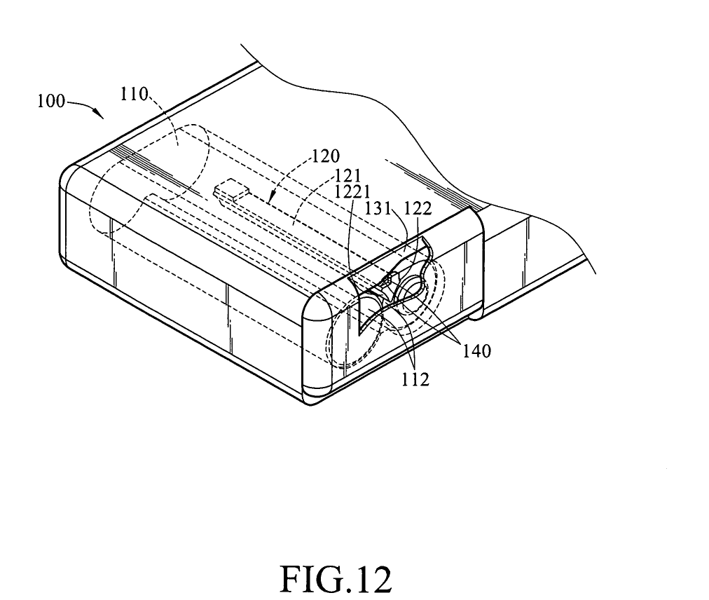

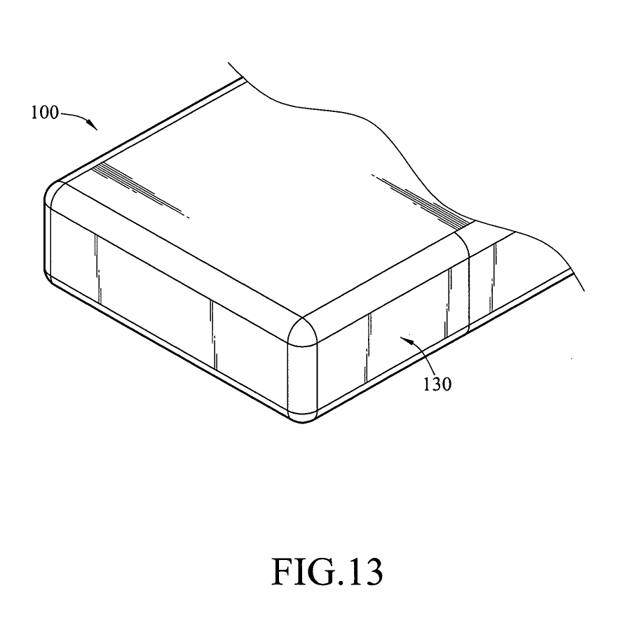

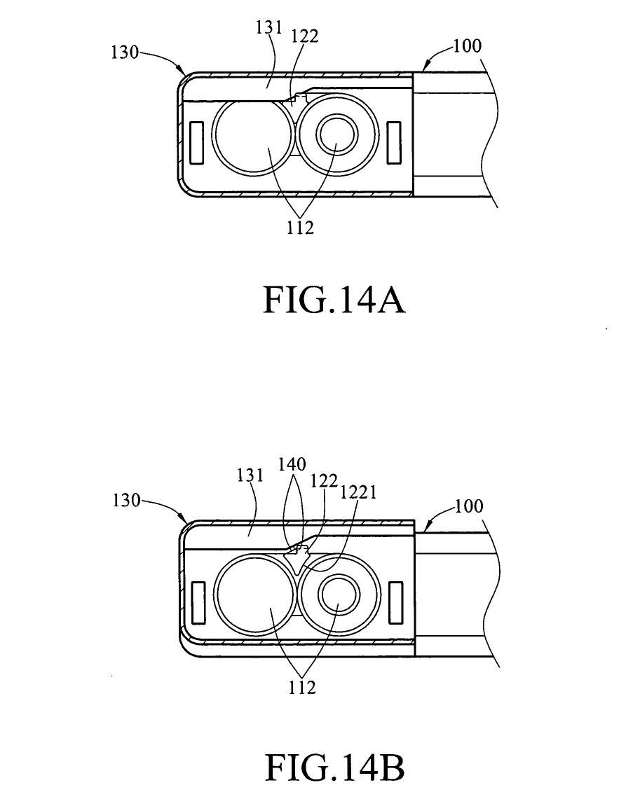

FIGS. 10 to 14B show schematic spatial views and schematic sectional views according to the third embodiment of the present invention. As shown in the figures, the cover 130 of the battery holding structure for the electronic device 100 is pivoted to one side of the opening 111 and selectively rotates and covers the opening 111 perpendicularly. The conductive spring sheet 150 is electrically contacted with the batteries 112 for conducting power. Moreover, the pressing portion 122 of the fixing member 120 presses against the batteries 112 due to the pressing force from the pushing portion 131 of the cover 130 in the perpendicular direction, so as to fix the batteries 112 at the electrically conducting position. When the user removes the cover 130 from the opening 111, the fixing member 120 is released by the pressing force and elastically recovered to the original position, and the batteries 112 fixed in the battery chamber 110 are loosened.

An arc-shaped structure 1221 matching the shape of the outer edge of the batteries 112 is disposed on one side of the pressing portion 122 relative to the plurality of batteries 112. When the cover 130 covers the opening 111, the arc-shaped structure 1221 of the pressing portion 122 is attached to the outer edge of the batteries 112 to obtain a more preferable pressing force, so as to avoid the loosening of the batteries 112 due to the excessively small contact area between the tubular batteries 112 and the pressing portion 122.

In the battery holding structure for an electronic device disclosed by the present invention, when the cover covers the opening of the battery chamber, the pushing portion presses against the corresponding pressing portion to fix the battery at an electrically conducting position, such that the battery in the electronic device is not easy to be powered off due to external forces such as shake and collision.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A battery holding structure for an electronic device, comprising:
a battery chamber, having an accommodation space with an opening, for installing a plurality of batteries;
a fixing member, having a cantilever disposed in said battery chamber and extending to the opening, wherein a pressing portion is disposed at the cantilever extending to the opening; and
a cover, for selectively covering the opening, having a pushing portion corresponding to said pressing portion, wherein when said cover covers the opening, said pushing portion presses against said pressing portion to fix the plurality of batteries.

2. The battery holding structure for an electronic device as claimed in claim 1, wherein said fixing member is disposed in a direction parallel to the axial direction of the plurality of batteries.

3. The battery holding structure for an electronic device as claimed in claim 1, wherein said pressing portion and said pushing portion are respectively provided with a corresponding inclined surface structure.

4. The battery holding structure for an electronic device as claimed in claim 1, wherein an arc-shaped structure is further disposed on one side of said pressing portion relative to the plurality of batteries, and when said cover covers the opening, the arc-shaped structure is attached to the outer edge of the battery.

5. The battery holding structure for an electronic device as claimed in claim 1, wherein said cover is selectively moved to cover the opening.

6. The battery holding structure for an electronic device as claimed in claim 1, wherein said cover is pivoted to one side of the opening and selectively moved to cover the opening.
